(19) United States
(12) Patent Application Publication
(10) Pub. No.: US 2006/0222931 A1
(43) Pub. Date: Oct. 5, 2006

(54) Connection of battery pack and cordless hand tools

(76) Inventor: Jack Lin, Nantou (TW)

Correspondence Address: PHILLIP LIU, 6980, WHITEOAK DR., RICHMOND, BC, V7EAZ9, CA

(21) Appl. No.: 11/091,462

(22) Filed: Mar. 29, 2005

(51) Int. Cl. H01M 2/10

(52) U.S. Cl. 429/100; 429/123; 429/97

(57) ABSTRACT

A cordless hand tool includes a barrel with a handle connected thereto and a connection part is connected to an underside of the handle. The connection part includes a first conductive assembly. A battery pack is removably connected to the connection part and has a second conductive assembly which is in contact with the first conductive assembly. A front side of the battery pack is in flush with a front side of the handle so that the hand tool can be moved toward the object to be screwed without being interrupted by any protrusion from the battery pack.

### FIELD OF THE INVENTION

The present invention relates to a battery pack which is axially connected to the handle of a cordless hand tool and the front side of the battery pack is in flush with the handle.

### BACKGROUND OF THE INVENTION

A conventional power hand tool such as cordless drill generally includes a handle connected with a barrel and a battery pack is connected to an underside of the handle so as to power the drill. The battery pack generally is a cubic pack which is sized such that the front end of the battery pack protrudes from the front and rear side of the handle. The protrusion portions of the battery pack affect the user to operate the drill in a narrow space. The user has to rotate the drill at an angle to move the handle closer to the object to be screwed. The battery pack is heavy so that the user cannot maintain the pose for a long time.

The present invention intends to provide a battery pack that is slim and connected to the handle of a cordless hand tool axially with its front side being in flush with the font side of the handle so that the drill can be moved much closer to the object to be screwed.

### SUMMARY OF THE INVENTION

The present invention relates to a cordless hand tool which comprises a barrel and a handle is connected to the barrel. The handle includes a connection part connected to an underside thereof and a first conductive assembly is connected to the connection part. A battery pack is removably connected to the connection part and has a second conductive assembly which is in contact with the first conductive assembly. A front side of the battery pack is in flush with a front side of the handle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the cordless hand tool and the battery pack of the present invention;

FIG. 2 shows that the locking member of the battery pack is hooked to the engaging port in the connection part;

FIG. 3 shows that the button is pushed when the battery pack is to be connected with the connection part, and

FIG. 4 shows the battery pack is connected to the connection part of the cordless hand tool.

### DETAILED DESCRIPTION OF THE PREFERRED EMBODIMENT

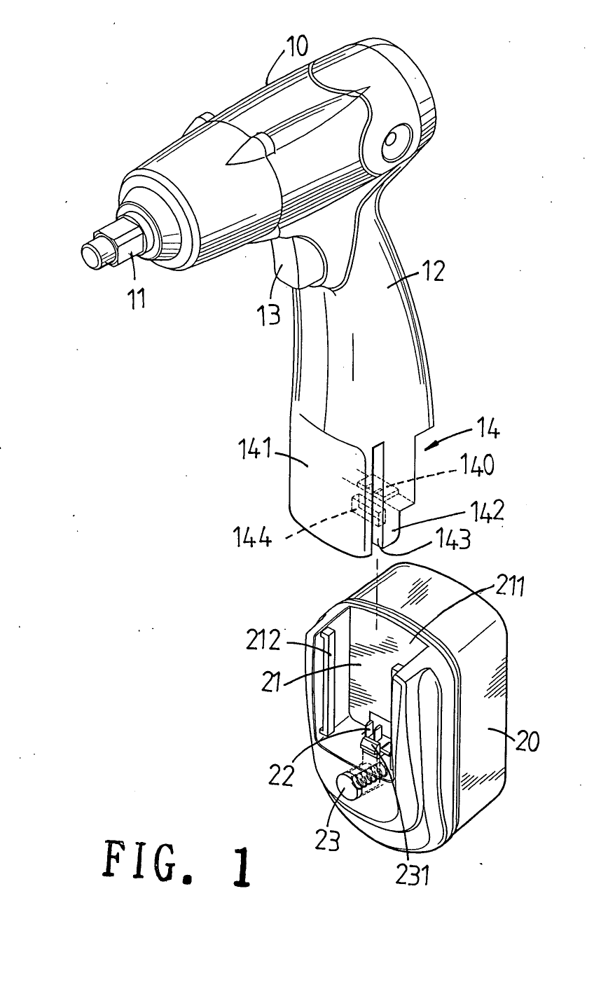

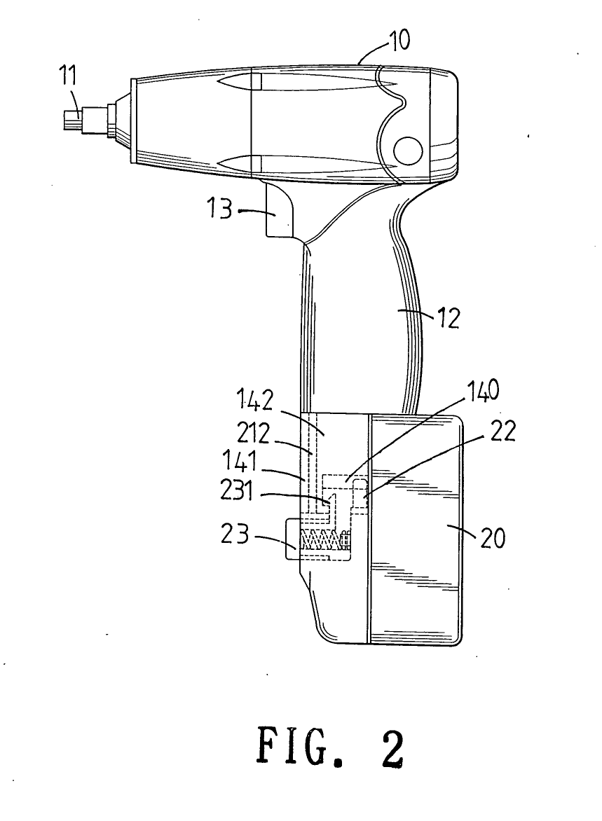

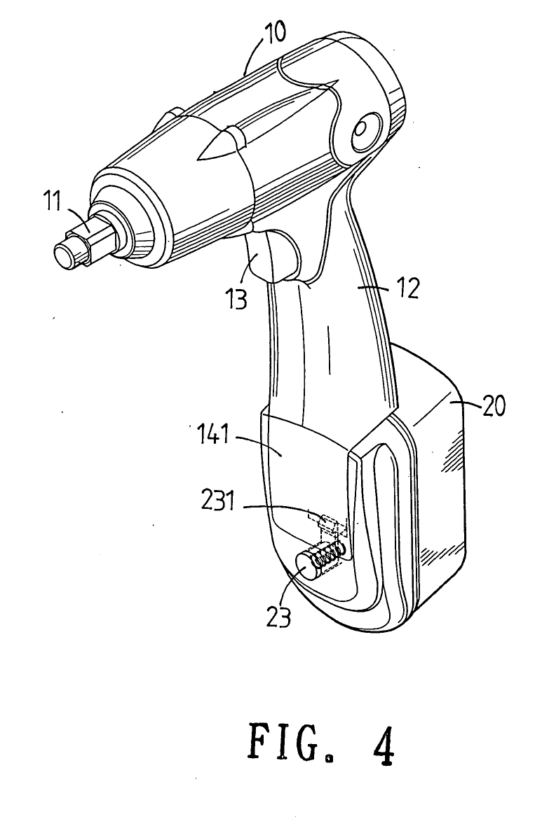

Referring to FIGS. 1 to 4, the cordless hand tool such as a battery-powered cordless drill of the present invention comprises a barrel 10 having a driving end 11 at a front end thereof and a handle 12 is connected to the barrel 10 which has a trigger 13 which is squeezed to activate the driving end 11. A connection part 14 is connected to an underside of the handle 12 and includes a first extension 141 and a second extension 132 extending axially from the underside of the handle 12. A slot 143 is defined between the first extension 141 and the second extension 132. A front side of the first extension 141 is in flush with a front side of the handle 12 and an engaging port 144 is defined in a rear side of the second extension132. A first conductive assembly is connected to the second extension 142 and located above the engaging port 144.

A battery pack 20 has a recess 21 defined in a front side thereof and an opening 211 is defined through a top of the battery pack 20 and in communication with the recess 21. A second conductive assembly 22 is located in an inside of the recess 21. A front side of the battery pack 20 is in flush with the front side of the handle 12. Two ridges 212 extend inward from two opposite insides of the recess 21 and are movably engaged with the slot 143 in the connection part 14. A locking member 231 such as a hook movably connected to a first end of a spring and a button 23 is connected to a second end of the spring. The button 23 is exposed from the front side of the battery pack 20.

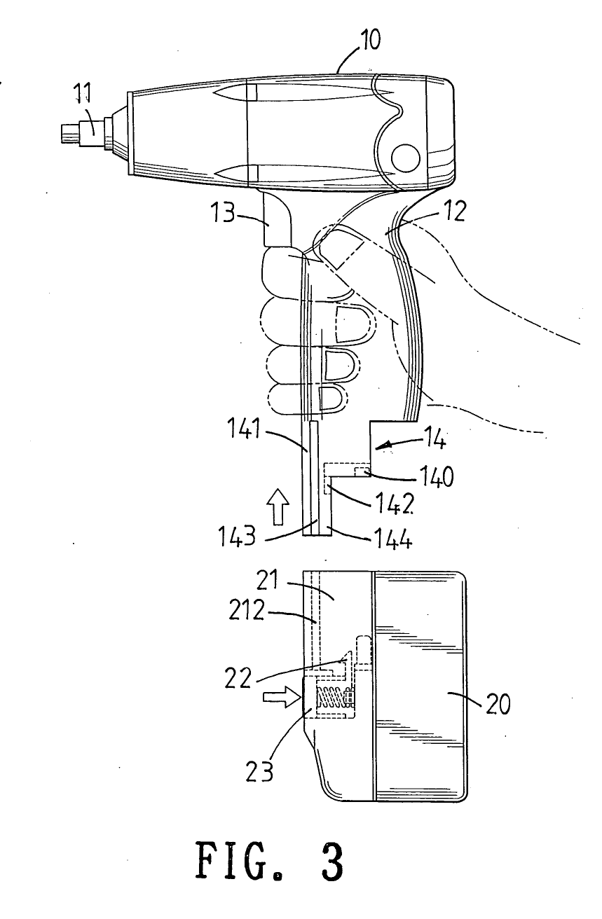

As shown in FIG. 3, when installing the battery pack 20 to the connection part 14, the user pushes the button 23 to move the locking member 231 horizontally and the two ridges 212 are then slid in the slot 143 of the connection part 14 till the lock member 231 hooked with the engaging port 144 so that the battery pack 20 is combined with the connection part 14. The first conductive assembly 140 is in contact with the second conductive assembly 22.

The front side of the handle 12 and the front side of the battery pack 20 are in flush with each other so that there is no protrusion extending from the lower end of the handle as seen on conventional battery pack such that the handle 12 is allowed to be moved closer to the object to be screwed.

While we have shown and described the embodiment in accordance with the present invention, it should be clear to those skilled in the art that further embodiments may be made without departing from the scope of the present invention.

What is claimed is:

1. A cordless hand tool comprising:
a barrel having a handle connected to the barrel, a connection part connected to an underside of the handle, a first conductive assembly connected to the connection part, and
a battery pack removably connected to the connection part and having a second conductive assembly which is in contact with the first conductive assembly, a front side of the battery pack being in flush with a front side of the handle.

2. The tool as claimed in claim 1, wherein the connection part includes a first extension and a second extension extending axially from the underside of the handle, a slot is defined between the first extension and the second extension, a front side of the first extension is in flush with the front side of the handle and an engaging port is defined in a rear side of the second extension, a first conductive assembly connected to the second extension, the battery pack has a recess defined in a front side thereof and an opening is defined through a top of the battery pack and in communication with the recess, a second conductive assembly is located in an inside of the recess, the battery pack having a locking member which is engaged with the engaging port.

3. The tool as claimed in claim 2, wherein two ridges extend inward from two opposite insides of the recess and are movably engaged with the slot in the connection part.

4. The tool as claimed in claim 2, wherein the locking member is a hook and movably connected to a first end of a spring, a button connected to a second end of the spring so that the locking member is moved horizontally by pushing the button.
